(19) United States
(12) Patent Application Publication
(10) Pub. No.: US 2006/0252451 A1
(43) Pub. Date: Nov. 9, 2006

(54) Transmission power control device and method

(76) Inventors: Sung Rae Cho, Busan (KR); Seong Su Park, Daejeon (KR); Hoo Sung Lee, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/429,729

(22) Filed: May 8, 2006

(30) Foreign Application Priority Data
May 6, 2005 (KR) 10-2005-0037969
Mar. 27, 2006 (KR) 10-2006-0027364

(51) Int. Cl. H04B 7/00; H04Q 7/20

(52) U.S. Cl. 455/522

(57) ABSTRACT

Provided is a transmission power control device and method calculating a compensated estimated signal-to-interference ratio (SIR) by subtracting an SIR margin according to change in the state of a receiving channel when measuring an estimated SIR of a reception signal at a receiving end, and determining an increase or decrease in transmission power according to a difference between the compensated estimated SIR and a target SIR, thereby providing a variable SIR margin threshold for TPC bit decision and preventing unnecessary cyclic redundancy check (CRC) errors and untimely change of the target SIR. Therefore, it is possible to efficiently reduce transmission and reception power consumption due to slow update of an existing target SIR, and to prevent a cyclic redundancy check (CRC) error caused by the untimely change of the target SIR.

### CROSS-REFERENCE TO RELATED APPLICATION

This application claims priority to and the benefit of Korean Patent Application No. 2005-37969, filed May 6, 2005 and Korean Patent Application No. 2006-27364, filed Mar. 27, 2006, the disclosure of which is incorporated herein by reference in its entirety.

### BACKGROUND

1. Field of the Invention

The present invention relates to a transmission power control device and method, and more particularly, to a transmission power control device and method that can efficiently reduce transmission and reception power consumption and prevent a cyclic redundancy check (CRC) error caused by slow update of an existing target signal-to-interference ratio (SIR).

2. Discussion of Related Art

In general, in a mobile communication system, when information is sent and received between a mobile station and a base station, the mobile station appropriately measures an estimated SIR according to a distance from the base station, a current state of received radio waves, and its own movement, and then compares the estimated SIR to a target SIR satisfying quality of service (QoS). When the estimated SIR is less than the target SIR, the mobile station sends a transmit power control (TPC) command to increase a transmission power to the base station. On the contrary, when the estimated SIR is more than the target SIR, the mobile station sends a TPC command to reduce the transmission power. And then, the base station adjusts a forward transmission power according to the TPC command received from the mobile station in order to allow a transmission power of a channel signal received by the mobile station to have a uniform level. Such a process is an inner-loop power control method.

According to the inner-loop power control method described above, power control is performed by taking a target SIR as a reference. However, in an actual mobile communication system, a reference for evaluating quality of a wireless channel signal may be a frame error rate (FER) rather than the SIR. Here, the FER indicates a limit of an error rate of a digital signal required for providing fine-quality voice, which is closely correlated with user satisfaction. Therefore, an FER capable of maintaining a desirable level of quality of the wireless channel signal, i.e., a target FER, has been set up appropriately for characteristics of a mobile communication system.

However, when power control is performed according to the closed-loop power control method, an actually-measured FER varies according to a channel environment even if an SIR does not vary, provided SIR is measured in an ensemble average regardless of a channel situation. Therefore, an FER that is higher or lower than a target FER is obtained, and in result, the corresponding relation between the SIR and the FER varies irregularly according to external factors such as a channel environment and a movement speed of the mobile station.

Therefore, power control that does not fix a target SIR to a specific value but makes the target SIR vary in accordance with a channel situation, and maintains the target FER in the result, is necessary. Such a power control method is an outer-loop power control method.

According to the outer-loop power control method, a desired specific performance metric, e.g., a target SIR used for the closed-loop power control method to uniformly maintain the target FER, varies in accordance with a channel situation.

More specifically, according to the outer-loop power control method, a CRC is performed on a received frame. When no error occurs in the received frame as a result of the CRC, a target SIR is reduced in decrease units of a relatively small power level. And, when an error occurs in the received frame as a result of the CRC, the target SIR increases in increase units of a relatively large power level. In other words, the outer-loop power control method adjusts the target SIR so that an FER in an actual channel situation is made to converge to the target FER.

The outer-loop power control method has an advantage in that it is possible to stably and uniformly maintain the quality of a receiving channel signal in a poor channel environment. However, the outer-loop power control method reduces a transmission power by a small value several times in a good channel situation, and increases the transmission power by a relatively large value in a poor channel situation. Therefore, when a state of a receiving channel abruptly varies, a target SIR should be timely reflected corresponding to the variation but repsonses slowly (takes approximately 10 ms) by the power control process described above. In result, the outer-loop power control method has a problem of consuming more power than necessary.

Moreover, when a number of transmitting channels are dynamically changed due to use of various types of content, a bit rate of a dedicated physical data channel (DPDCH) dynamically varies in units of the minimum frame of each transport channel (TrCH) during a multiplexing process for many TrCHs, and thus different target SIRs are required and eventually the highest one of TrCH specific target SIRs is coupled with the inner-loop power control method. Hereupon, when the demanded target SIRs show a large deviation, power control, based on the highest one of the target SIRs, results in considerably increased power consumption.

In result, when the state of the receiving channel frequently varies and the number of TrCHs is dynamically changed due to use of various types of content, according to the outer-loop power control method, the target SIR responses untimely and unnecessarily compared to variation of a state of the receiving channel. Transmission power is therefore consumed unnecessarily, because reception quality deteriorates and retransmission of a frame can be required.

### SUMMARY OF THE INVENTION

The present invention is directed to a transmission power control device and method, when measuring an estimated signal-to-interference ratio (SIR) of a reception signal at a receiving end, calculating the estimated SIR compensated by subtracting an SIR margin according to change in the state of a receiving channel, determining an increase or decrease in transmission power according to a difference between the compensated estimated SIR and a target SIR, and providing a variable critical value for transmit power control (TPC) bit decision, thereby preventing temporary dynamic variation of the target SIR and thus efficiently reducing transmission and reception power consumption and preventing a cyclic redundancy check (CRC) error caused by slow update of an existing target SIR.

One aspect of the present invention provides a transmission power control device comprising: an SIR measurement unit for measuring an estimated SIR, which is the ratio of the power of a reception signal to an interference power through an averaging process, compensating the measured estimated SIR according to a state of a receiving channel, and outputting the compensated estimated SIR; a target SIR setting unit for setting a target SIR using the reception signal; an SIR margin setting unit for receiving the measured estimated SIR and recognizing a state of the receiving channel, and then setting an SIR margin and outputting the set SIR margin to the SIR measuring unit; an SIR comparison and TPC command information generation unit for comparing the compensated estimated SIR with the target SIR, and then generating TPC command information according to an SIR error value of the compensated estimated SIR with respect to the target SIR and outputting the TPC command information; and a transmission power controller for adjusting a transmission power level using the SIR margin output from the SIR margin setting unit.

Another aspect of the present invention provides a transmission power control method comprising: a first step of measuring an estimated SIR, which is the ratio of the power of a reception signal to an interference power through an averaging process; a second step of calculating a fluctuation degree of the measured estimated SIR to recognize a state of a receiving channel and setting an SIR margin according to the calculated fluctuation degree; a third step of compensating the measured estimated SIR according to the set SIR margin; a fourth step of comparing the compensated estimated SIR with a target SIR, and then generating TPC command information according to an SIR error value of the compensated estimated SIR with respect to the target SIR and outputting the TPC command information; and a fifth step of setting a TPC step size using the set SIR margin to adjust a transmission power level.

### BRIEF DESCRIPTION OF THE DRAWINGS

The above and other features and advantages of the present invention will become more apparent to those of ordinary skill in the art by describing in detail preferred exemplary embodiments thereof with reference to the attached drawings in which:

FIG. 1 is a block diagram of wireless communication equipment employing a transmission power control device according to an exemplary embodiment of the present invention; and

FIG. 2 illustrates operation of a transmission power control information provider of the transmission power control device according to an exemplary embodiment of the present invention.

### DETAILED DESCRIPTION OF EXEMPLARY EMBODIMENTS

Hereinafter, exemplary embodiments of the present invention will be described in detail. However, the present invention is not limited to the exemplary embodiments disclosed below and can be implemented in various forms. Therefore, the present exemplary embodiments are provided for complete disclosure of the present invention and to fully inform the scope of the present invention to those of ordinary skill in the art.

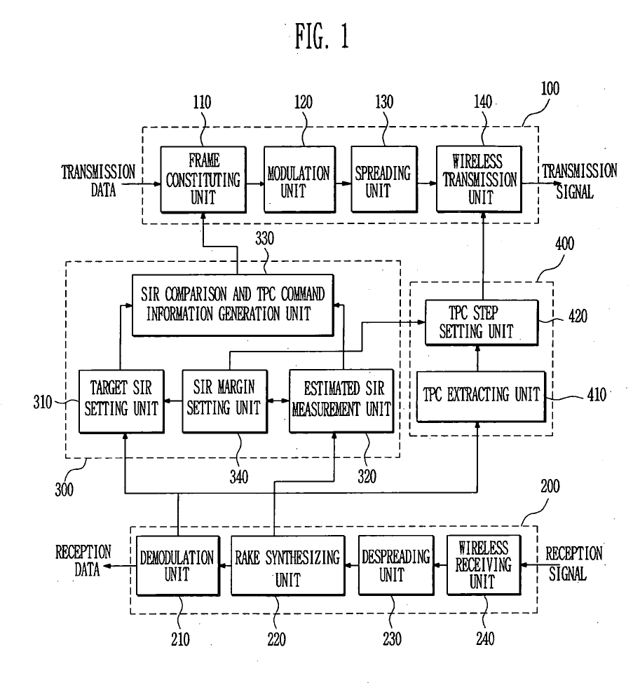

FIG. 1 is an overall block diagram of wireless communication equipment employing a transmission power control device according to an exemplary embodiment of the present invention.

Referring to FIG. 1, the wireless communication equipment employing a transmission power control device according to the exemplary embodiment of the present invention comprises a transmission module 100, a receiving module 200, a transmission power control information provider 300, and a transmission power controller 400.

The transmission power control device according to the exemplary embodiment of the present invention can be applied to a cellular phone, mobile terminal equipment having both a cellular phone function and a computer function, mobile station equipment, base station equipment performing wireless telecommunication, and so forth, in order to reduce transmission power consumption due to mobility or temporary deterioration of a reception state in a mobile communication wireless transceiver system.

Here, the transmission module 100 performs a function of outputting transmission data input from the outside as a predetermined transmission signal through a modulating process, a spreading process, and so forth.

The transmission module 100 includes a frame constituting unit 110, a modulation unit 120, a spreading unit 130, and a wireless transmission unit 140.

The frame constituting unit 110 performs functions of receiving transmission data from outside and transmission power control (TPC) command information, i.e., TPC bit information, output from a signal-to-interference ratio (SIR) comparison and TPC command information generation unit 330 of the transmission power control information provider 300 that will be described below, and outputting the TPC command information in a predetermined transmission frame.

The modulation unit 120 performs functions of modulating the transmission frame output from the frame constituting unit 110 according to, e.g., a code division multiple access (CDMA) method and outputting the modulated transmission frame to the spreading unit 130.

The spreading unit 130 performs a function of spreading a signal output from the modulation unit 120.

The wireless transmission unit 140 performs a predetermined wireless process for a signal output from the spreading unit 130 and a function of outputting a transmission signal. Although not shown in the drawings, the transmission signal output from the wireless transmission unit 140 is output to an antenna through a predetermined transmission and reception signal separating unit.

Here, the wireless transmission unit 140 receives a TPC step size output from a TPC step setting unit 420 of the transmission power controller 400, which will be described below, adjusts a transmission power level, and outputs the transmission signal.

Meanwhile, the receiving module 200 performs a function of outputting a reception signal input from the outside as predetermined reception data through a dispreading process, a rake-synthesizing process, a demodulating process, and so forth.

The receiving module 200 includes a demodulation unit 210, a rake synthesizing unit 220, a despreading unit 230, and a wireless receiving unit 240.

Here, the wireless receiving unit 240 receives the reception signal input through the antenna (not shown in the drawings) and the transmission and reception signal separating unit (not shown in the drawings), and performs a predetermined wireless process.

The despreading unit 230 performs despreading on a signal output from the wireless receiving unit 240.

The rake synthesizing unit 220 performs rake-synthesis of a signal output from the despreading unit 230, and the demodulation unit 210 performs demodulation of a signal output from the rake synthesizing unit 220 and outputs predetermined reception data.

Meanwhile, the transmission power control information provider 300 includes a target SIR setting unit 310, an estimated SIR measurement unit 320, the SIR comparison and TPC command information generation unit 330, and an SIR margin setting unit 340.

Here, the target SIR setting unit 310 performs functions of setting a target SIR according to a signal output from the demodulation unit 210 of the receiving module 200 and whether or not an SIR margin is set by the SIR margin setting unit 340, and outputting the set target SIR to the SIR comparison and TPC command information generation unit 330.

The estimated SIR measurement unit 320 performs functions of receiving a synthesized signal output from the rake synthesizing unit 220 of the receiving module 200, measuring an estimated SIR through an averaging process that will be described below, outputting the measured estimated SIR to the SIR margin setting unit 340, receiving an SIR margin from the SIR margin setting unit 340, and compensating the measured estimated SIR

The SIR comparison and TPC command information generation unit 330 performs functions of comparing the estimated SIR compensated by the estimated SIR measurement unit 320 with the target SIR set by the target SIR setting unit 310, and then generating and outputting predetermined TPC command information to the frame constituting unit 110 of the transmission module 100.

The SIR margin setting unit 340 performs functions of receiving the measured estimated SIR output from the estimated SIR measurement unit 320, calculating a fluctuation degree of the estimated SIR to recognize change in the state of a receiving channel, comparing the fluctuation degree with a predetermined SIR margin threshold, setting the SIR margin, and then outputting the set SIR margin to the estimated SIR measurement unit 320 and the TPC step setting unit 420 of the transmission power controller 400, which will be described below.

When the SIR margin is set by the SIR margin setting unit 340, the target SIR setting unit 310 fixes the target SIR without reducing the target SIR in decrease units of a power level or increasing the target SIR in increase units taking a block error rate (BLER) measured by a CRC checksum as a reference.

More specifically, when a state of the receiving channel is abruptly changed as described in discussion of the related art, the target SIR is not changed, but a proper SIR margin is subtracted from the power of the reception signal. Thus, the estimated SIR is relatively lowered corresponding to temporary change in the state of radio waves to increase a transmission power.

Meanwhile, the transmission power controller 400 includes a TPC extracting unit 410, and the TPC step setting unit 420.

Here, the TPC extracting unit 410 performs functions of extracting a TPC bit from the output signal demodulated by the demodulation unit 210 of the receiving module 200 and outputting the TPC bit to the TPC step setting unit 420.

The TPC step setting unit 420 performs functions of receiving the SIR margin output from the SIR margin setting unit 340 and the TPC bit output from the TPC extracting unit 410, setting the TPC step size, and outputting the TPC step size to the wireless transmission unit 140 of the transmission module 100.

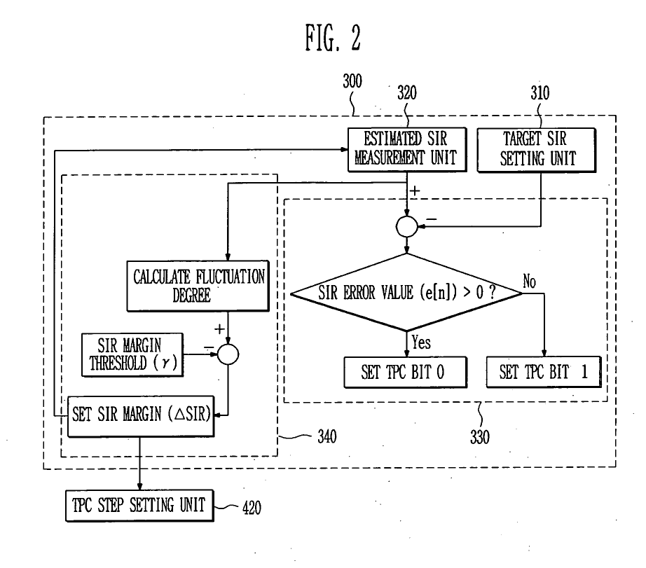

FIG. 2 illustrates operation of the transmission power control information provider of the transmission power control device according to an exemplary embodiment of the present invention.

Referring to FIG. 2, first, the estimated SIR measurement unit 320 measures an estimated SIR ^{ESIR[n]}, which is the ratio of the power of a reception signal to an interference power through the averaging process according to Formula 1 given below.

$$ESIR [ n ] = {\sum }_{k = 1}^{L} \frac{E ( {Signalpower}_{k} [ n ] )}{E ( {Interference}_{k} [ n ] )} \qquad Formula 1$$

Here, ^{E(Signalpower [n])} is the power of the reception signal and is defined as follows:
E(Signalpower[n])=(1−α₁)×E(Signalpower[n]−1)+α₁×Signalpower[n](0<α₁,α₂<1).
Also, ^{E(Inter ference [n])} is an interference value of the reception signal and is defined as follows:
E(Interference[n])=(1−α₂)×E(Interference[n−1])+α₂×Intereference[n](0<α₁,α₂<1).

Describing Formula 1 in further detail, when a reception signal power and an interference value of an i-th slot of a k-th finger measured during a sampling period T of a dedicated physical channel (DPCH) pilot field bit among L number of fingers output from the rake synthesizing unit 220 (refer to FIG. 1) of the receiving module 200 are respectively defined as ^{signalpower}^{ₖ}^{[i]} and ^{Interference}^{ₖ}^{[i].}, the estimated SIR measurement unit 320 calculates an estimated SIR ^{ESIR[n]} of an n-th slot according to Formula 1 using a moving average of a weight parameter ^{α}.

Subsequently, associated with the following calculation of a metric showing stability of received radio waves, the SIR margin setting unit 340 calculates a receiving signal fluctuation degree ^{D[n]} of the n-th slot according to the following Formula 2 using averaging of multipath reception signal change.
D[n]=β×D[n−1]+(1−β)×(Signalpower₁[n]−Signalpower₂ [n])² Formula 2
Here, 0<β1, and ^{Signalpower}^{₁}^{[n]} and ^{Signalpower}^{₂}^{[n]} denote the strongest finger signal and the second strongest finger signal, respectively.

Subsequently, the SIR margin setting unit 340 determines whether or not the fluctuation degree ^{D[n]} of the n-th slot exceeds an SIR margin threshold γ as shown in Formula 3 given below.
D[n]≧γ Formula 3

Here, the SIR margin threshold γ is a parameter that can be adjusted by a telecommunication provider according to a profile of each mobile station user. As the SIR margin threshold γ becomes low, a probability that a SIR margin will be applied increases. On the contrary, as the SIR margin threshold γ becomes high, the probability decreases.

Subsequently, when the fluctuation degree ^{D[n]} of the n-th slot exceeds the SIR margin threshold γ, the SIR margin setting unit 340 sets and outputs an n-th margin ^{ΔSIR[n]} to the estimated SIR measurement unit 320 and the TPC step setting unit 420.

The SIR margin ^{ΔSIR[n]} set by the SIR margin setting unit 340 is for compensating the estimated SIR ^{ESIR[n]} n measured by the estimated SIR measurement unit 320, ranges from 0 dB to 1 dB, and may be reset in proportion to increase of a CRC check error rate.

The SIR margin ^{ΔSIR[n]} set by the SIR margin setting unit 340 is output to the estimated SIR measurement unit 320, and hereupon, the estimated SIR measurement unit 320 compensates the estimated SIR according to Formula 4 given below.
\overline{ESIR[n]}=10 log₁₀ ESIR[n]−ΔSIR[n] Formula 4

More specifically, the compensated estimated SIR ^{\overline{ESIR[n]}} is obtained by subtracting the SIR margin ^{ΔSIR[n]} set by the SIR margin setting unit 340 from the estimated SIR ^{ΔESIR[n]} measured by the estimated SIR measurement unit 320.

Meanwhile, when the estimated SIR is compensated according to the SIR margin as described above, it is preferable for the target SIR setting unit 310 to fix a target SIR without reducing the target SIR in decrease units of a power level or increasing the target SIR in increase units taking a BLER measured by a CRC checksum as a reference.

Subsequently, the SIR comparison and TPC command information generation unit 330 calculates an SIR error ^{e[n]} value between the estimated SIR \overline{ESIR[n]} compensated by the estimated SIR measurement unit 320 and the target SIR ^{SIR}^{_{target}} of the n-th slot output from the target SIR setting unit 310 according to Formula 5 given below.
e[n]10 log₁₀\overline{ESIR[n]}−SIR_{target} Formula 5
Here, the SIR comparison and TPC command information generation unit 330 sets a TPC bit to 0 when the SIR error value ^{e[n]} is more than 0, or else sets the TPC bit to 1.

Meanwhile, the TPC step setting unit 420 sets a TPC step size using the SIR margin ^{ΔSIR[n]} output from the SIR margin setting unit 340 in order to adjust a transmission power level. When the TPC step size varies, the TPC step size ^{Δ}^{_{RP−TPC}} is calculated according to Formula 6 given below.
Δ_{RP-TPC}=Δ_{TPC}+η×ΔSIR

Here, ^{Δ}^{_{RP−TPC}} is the TPC step size of a recovery period, and does not exceed the maximum 3 dB. In addition, η is a scaling factor due to a difference between characteristics of an uplink channel and a downlink channel.

More specifically, considering the effects of mutual interference between a transmission signal and the reception signal, the TPC step setting unit 420 receives the SIR margin from the SIR margin setting unit 340 and temporarily increases or decreases the TPC step size, thereby increasing or decreasing the transmission power without unnecessarily changing the target SIR when a reception state temporarily deteriorates. Thus, reception quality is maintained, and a delay time to converge to the target SIR is reduced.

Meanwhile, as described above, when reception quality is abruptly changed due to deep fading and shadowing caused by sudden movement of a mobile station, as for a universal mobile telecommunication system (UMTS) service, a spreading gain is dynamically changed by the effects of various service qualities and a variable bit rate (VBR) service, and thus an estimated SIR may considerably fluctuate. In this case, like in the conventional art, when the estimated SIR is compared with a target SIR according to each slot and the target SIR is changed in accordance with a channel situation, unnecessary power is consumed.

Therefore, in order to prevent such unnecessary power consumption, when a state of a receiving channel frequently varies and a number of transmitting channels dynamically varies due to use of various types of content, the present invention senses change in the state of the receiving channel at a receiving end, differently sets an SIR margin according to the change in the state of the receiving channel, and subtracts the set SIR margin from an estimated SIR, thereby allowing a receiving station to make the best TPC decision according to quality of a reception signal.

More specifically, the present invention subtracts an SIR margin from an estimated SIR according to change in the state of a receiving channel, and thereby provides a variable SIR margin threshold for resilient TPC bit decision, according to a difference between the estimated SIR and a target SIR when determining increase or decrease in transmission power. Therefore, the present invention can efficiently reduce transmission and reception power consumption by the channel-adaptive SIR estimation, which mitigates the effect of slow update of the target SIR and prevents a CRC error caused by the untimely change of the target SIR, thereby actively preventing deterioration of reception quality.

In addition, the present invention may be associated with dynamic adjustment of a target SIR and change of a TPC update period, a TPC decision threshold range, and a dynamic TPC step size. The present invention requires a transmitting station to modify a variable TPC step size according to a TPC decision made by a receiving station, but can maintain compatibility with transmitting stations defined by conventional standards.

As described above, the transmission power control device and method according to the present invention calculate a compensated estimated SIR by subtracting an SIR margin according to change in the state of a receiving channel from an estimated SIR when the estimated SIR is measured at a receiving end, and determines increase or decrease in transmission power according to a difference between the compensated SIR and a target SIR, thereby providing a variable SIR margin threshold for TPC bit decision and preventing temporary dynamic variation of the target SIR. Therefore, it is possible to efficiently reduce transmission and reception power consumption due to slow update of an existing target SIR, and to prevent a CRC error caused by the untimely change of the target SIR.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A transmission power control device comprising:
a signal-to-interference ratio (SIR) measuring unit for measuring an estimated SIR, which is the ratio of the power of a reception signal to an interference power through an averaging process, compensating the measured estimated SIR according to a state of a receiving channel, and outputting the compensated estimated SIR;
a target SIR setting unit for setting a target SIR using the reception signal;
an SIR margin setting unit for receiving the measured estimated SIR and recognizing a state of the receiving channel, and then setting an SIR margin and outputting the set SIR margin to the SIR measuring unit;
an SIR comparison and transmit power control (TPC) command information generation unit for comparing the compensated estimated SIR with the target SIR, and then generating TPC command information according to an SIR error value of the compensated estimated SIR with respect to the target SIR, and outputting the TPC command information; and
a transmission power controller for adjusting a transmission power level using the SIR margin output from the SIR margin setting unit.

2. The transmission power control device according to claim 1, wherein the SIR measurement unit subtracts the SIR margin output from the SIR margin setting unit from the measured estimated SIR, thereby compensating the measured estimated SIR.

3. The transmission power control device according to claim 1, wherein the transmission power controller comprises:
a TPC extracting unit for extracting a TPC bit from the reception signal; and
a TPC step size setting unit for receiving the set SIR margin and the extracted TPC bit and setting a TPC step size in order to adjust the transmission power level.

4. A transmission power control method comprising:
a first step of measuring an estimated signal-to-interference ratio (SIR), which is the ratio of the power of a reception signal to an interference power through an averaging process;
a second step of calculating a fluctuation degree of the measured estimated SIR in order to recognize a state of a receiving channel, and setting an SIR margin according to the calculated fluctuation degree;
a third step of compensating the measured estimated SIR according to the set SIR margin;
a fourth step of comparing the compensated estimated SIR with a target SIR, and then generating transmit power control (TPC) command information according to an SIR error value of the compensated estimated SIR with respect to the target SIR and outputting the TPC information; and
a fifth step of setting a TPC step size using the set SIR margin to adjust a transmission power level.

5. The transmission power control method according to claim 4, wherein in the first step, the estimated SIR ^{ESIR[n]} is measured by the following formula:
$$ESIR [ n ] = {\sum }_{k = 1}^{L} \frac{E ( {Signalpower}_{k} [ n ] )}{E ( {Interference}_{k} [ n ] )} ,$$
where ^{E(Signalpower [n])} is the power of the reception signal and ^{E(Inter ference [n])} is an interference value of the reception signal.

6. The transmission power control method according to claim 4, wherein in the second step, the fluctuation degree ^{D[n]} of the measured estimated SIR is calculated by the following formula:
D[n]=β×D[n−1]+(1−β)×(Signalpower₁[n]−Signalpower₂ [n])^{2 (}0<β<1),
where ^{Signalpower}^{₁}^{[n]} is the strongest finger signal among finger signals measured during a sampling period of the reception signal, and ^{Signalpower}^{₂}^{[n]} is the second strongest finger signal among finger signals measured during a sampling period of the reception signal.

7. The transmission power control method according to claim 4, wherein in the second step, when the fluctuation degree of the measured estimated SIR exceeds a predetermined SIR margin threshold, the SIR margin is set to a value between 0 dB and 1 dB.

8. The transmission power control method according to claim 4, wherein in the third step, the compensated estimated SIR ^{\overline{ESIR[n]}} is calculated by the following formula:
\overline{ESIR[n]}=10 log₁₀ESIR[n]−ΔSIR[n],
where ^{ΔSIR[n]} is the set SIR margin and ^{ESIR[n]} is the measured estimated SIR.

9. The transmission power control method according to claim 4, further comprising, when in the third step, the measured estimated SIR is compensated, a sixth step of fixing the target SIR.

10. The transmission power control method according to claim 4, wherein in the fourth step, the SIR error value ^{e[n]} of the compensated estimated SIR with respect to the target SIR is calculated by the following formula:
e[n]10 log₁₀\overline{ESIR[n]}−SIR_{target},
where ^{SIR}^{_{target}} is the target SIR and ^{\overline{ESIR[n]}} is the compensated estimated SIR.

11. The transmission power control method according to claim 4, wherein in the fourth step, a TPC bit is set to 0 when the SIR error value is more than 0, and the TPC bit is set to 1 when the SIR error value is less than 0.

12. The transmission power control method according to claim 4, wherein in the fifth step, the TPC step size ^{Δ}^{_{RP−TPC}} is set by the following formula:
Δ_{RP-TPC}=Δ_{TPC}+η×ΔSIR,
where ^{ΔSIR[n]} is the set SIR margin and η is a scaling factor due to a difference between characteristics of an uplink channel and a downlink channel.
